(19) United States
(12) Patent Application Publication
(10) Pub. No.: US 2024/0175713 A1
(43) Pub. Date: May 30, 2024

(54) ELECTRONIC MAP SWITCHING METHOD, ELECTRONIC MAP PROCESSING METHOD, TERMINAL, SERVER, AND STORAGE MEDIUM

(71) Applicant: BOE Technology Group Co., Ltd., Beijing (CN)

(72) Inventor: Pengfei Zuo, Beijing (CN)

(73) Assignee: BOE Technology Group Co., Ltd., Beijing (CN)

(21) Appl. No.: 18/283,060

(22) PCT Filed: Jan. 4, 2023
(86) PCT No.: PCT/CN2023/070399

§ 371 Date: Sep. 20, 2023

(30) Foreign Application Priority Data
Jan. 29, 2022 (CN) 202210111756.8

(51) Int. Cl. G01C 21/00; G01C 21/20

(52) U.S. Cl. CPC G01C 21/387; G01C 21/206

(57) ABSTRACT

A method for switching an electronic map includes: in the case that a terminal navigates outside a target building, when it is detected that the terminal enters a transition region outside the target building, determining that the terminal needs to enter a room from the outside, then obtaining second electronic map data, and displaying a second electronic map according to the second electronic map data, to implement switching from an outdoor first electronic map to the indoor second electronic map; and in the case that the terminal navigates inside the target building, when it is detected that the terminal enters the transition region of the outside from the inside, determining that the terminal needs to exit the room to the outside, and then displaying the first electronic map according to first electronic map data, to implement switching from the indoor second electronic map to the outdoor first electronic map.

### CROSS REFERENCE TO RELEVANT APPLICATIONS

The present disclosure claims the priority of the Chinese patent application filed on Jan. 29, 2022 before the China National Intellectual Property Administration with the application number of 202210111756.8 and the title of “ELECTRONIC MAP SWITCHING METHOD, ELECTRONIC MAP PROCESSING METHOD, TERMINAL, SERVER, AND STORAGE MEDIUM”, which is incorporated herein in its entirety by reference.

### TECHNICAL FIELD

The present disclosure relates to the technical field of smart life and more particularly, to a method for switching an electronic map, a method for processing an electronic map, a terminal, a server and a storage medium.

### BACKGROUND

Electronic maps are usually provided by internet map manufacturers. Currently, internet map manufacturers have good support for electronic map data and navigation functions in outdoor public areas, but they do not support electronic map data and navigation functions in indoor private areas.

At present, some customizable indoor navigation software, mini-programs, etc. can achieve navigation in the indoor private area. For users, from outside to interior, or from the interior to the outside, they need to manually switch the software to switch the electronic maps.

### SUMMARY

In a first aspect, an embodiment of the present disclosure provides a method for switching an electronic map, applied to a terminal, and the method includes:
under the condition that a first electronic map is displayed according to first electronic map data, when it is detected that the terminal enters a transition region outside a target building, acquiring second electronic map data, wherein the transition region is adjacent to an area occupied by the target building;
displaying a second electronic map according to the second electronic map data, to achieve switching from the first electronic map to the second electronic map;
under the condition that the second electronic map is displayed according to the second electronic map data, when it is detected that the terminal enters the transition region from interior of the target building, displaying the first electronic map according to the first electronic map data, to achieve switching from the second electronic map to the first electronic map;
wherein the first electronic map data include electronic map data outside the target building, the second electronic map data include electronic map data of the interior of the target building and electronic map data of the transition region outside the target building; electronic map data of the transition region included in the first electronic map data and the electronic map data of the transition region included in the second electronic map data are capable of being converted to each other, and the transition region displayed in the first electronic map and the transition region displayed in the second electronic map are the same.

Optionally, the step of under the condition that a first electronic map is displayed according to first electronic map data, when it is detected that the terminal enters a transition region outside a target building, acquiring second electronic map data, includes:
under the condition that the first electronic map is displayed according to the first electronic map data, and navigation is performed by a first navigation mode based on remote positioning auxiliary signals, when a short-range positioning auxiliary signal sent by short-range positioning auxiliary devices is received, and it is detected that the terminal enters the transition region outside the target building, acquiring the second electronic map data;
wherein remote positioning auxiliary devices are provided outside the target building, the remote positioning auxiliary signals are sent by the remote positioning auxiliary devices, a quantity of the remote positioning auxiliary devices is greater than or equal to 3; the short-range positioning auxiliary devices are provided in the interior of the target building and/or in the transition region, and a quantity of the short-range positioning auxiliary devices is greater than or equal to 3;
the step of displaying a second electronic map according to the second electronic map data, to achieve switching from the first electronic map to the second electronic map, includes:
displaying the second electronic map according to the second electronic map data, and performing navigation by a second navigation mode based on the short-range positioning auxiliary signals, to achieve switching from the first electronic map to the second electronic map and switching from the first navigation mode to the second navigation mode.

Optionally, the step of under the condition that the second electronic map is displayed according to the second electronic map data, when it is detected that the terminal enters the transition region from interior of the target building, displaying the first electronic map according to the first electronic map data, to achieve switching from the second electronic map to the first electronic map, includes:
under the condition that the second electronic map is displayed according to the second electronic map data and navigation is performed by the second navigation mode, when it is detected that the terminal enters the transition region from the interior of the target building, displaying the first electronic map according to the first electronic map data, and performing navigation by the first navigation mode, to achieve switching from the second electronic map to the first electronic map and switching from the second navigation mode to the first navigation mode.

Optionally, the step of performing navigation by a second navigation mode based on the short-range positioning auxiliary signals includes:
during a movement process of the terminal in the interior of the target building or in the transition region, receiving the short-range positioning auxiliary signals sent by the short-range positioning auxiliary devices;
under the condition that the short-range positioning auxiliary signals sent by at least three short-range positioning auxiliary devices are received, according to position data of the at least three short-range positioning auxiliary devices included in the second electronic map data and received signal strength indications when the terminal receives the short-range positioning auxiliary signals, determining a first real-time position of the terminal;
according to road network data of the interior of the target building and the transition region included in the second electronic map data, and a starting position when the terminal enters the transition region and a required end position, determining a first navigation route of the terminal in the interior of the target building and in the transition region; and
performing navigation according to the first real-time position and the first navigation route.

Optionally, before the step of according to road network data of the interior of the target building and the transition region included in the second electronic map data, and a starting position when the terminal enters the transition region and a required end position, determining a first navigation route of the terminal in the interior of the target building and in the transition region, the method further includes:
acquiring resident positions that are spare and located in the interior of the target building in the second electronic map, and selecting one resident position from the resident positions as the end position;
or,
acquiring resident positions that are spare and located in the interior of the target building in the second electronic map; when the second electronic map is starting to display, displaying an end position selection interface according to the resident positions that are spare; when a selection operation by an end user for a target resident position in the resident positions that are spare is received in the end position selection interface, determining the target resident position as the end position.

Optionally, the step of performing navigation by the first navigation mode includes:
during a movement process of the terminal outside the target building, receiving the remote positioning auxiliary signals sent by the remote positioning auxiliary devices, wherein the remote positioning auxiliary signals carry sending times of the remote positioning auxiliary signals;
under the condition that the remote positioning auxiliary signals sent by at least three remote positioning auxiliary devices are received, generating initial positioning data according to the sending times and receiving times of the remote positioning auxiliary signals;
sending the initial positioning data to a positioning navigation server, so that the positioning navigation server determines a second real-time position of the terminal according to the initial positioning data and position data of the at least three remote positioning auxiliary devices, determines a second navigation route of the terminal outside the target building according to the second real-time position and road network data outside the target building, generates real-time navigation information according to the second real-time position and the second navigation route, and real-time sends the real-time navigation information to the terminal to navigate the terminal; and
receiving the real-time navigation information.

Optionally, according to position data of the at least three short-range positioning auxiliary devices included in the second electronic map data and received signal strength indications when the terminal receives the short-range positioning auxiliary signals, determining a first real-time position of the terminal includes:
regarding every three of the short-range positioning auxiliary devices of which the short-range positioning auxiliary signals are received as a device group, and grouping the at least three short-range positioning auxiliary devices included in the second electronic map data;
parsing the position data of the at least three short-range positioning auxiliary devices included in the second electronic map data;
determining a distance between the terminal and each of the short-range positioning auxiliary devices according to the received signal strength indications when the terminal receives the short-range positioning auxiliary signals;
for each of the short-range positioning auxiliary devices in each device group, regarding parsed position datum of the short-range positioning auxiliary devices as a center of circle, and regarding a distance between the terminal and each of the short-range positioning auxiliary devices as a radius, to draw a circle; and
for each device group, calculating a signal strength centroid of three circles corresponding to the device group, and averaging the signal strength centroids corresponding to the device groups to obtain the first real-time position of the terminal.

Optionally, the position data of the at least three short-range positioning auxiliary devices included in the second electronic map data is data obtained after compression processing and encryption processing in sequence, and the step of parsing the position data of the at least three short-range positioning auxiliary devices included in the second electronic map data includes:
performing decryption processing on the position data of the at least three short-range positioning auxiliary devices included in the second electronic map data; and
performing decompression processing on the position data of the at least three short-range positioning auxiliary devices after the decryption processing.

Optionally, the step of acquiring the second electronic map data includes:
when there is no second electronic map data currently stored in the terminal, downloading latest second electronic map data; and
when there is the second electronic map data currently stored in the terminal, and currently stored second electronic map data is not latest second electronic map data, downloading the latest second electronic map data.

Optionally, the method further includes:
when starting to download the latest second electronic map data, estimating a download duration required for the latest second electronic map data;
according to position information of an entrance of the target building included in the first electronic map data and a movement speed of the terminal entering the transition region, estimating a movement duration of the terminal from entering the transition region to moving to the entrance of the target building; and
when the download duration is greater than the movement duration, outputting prompt information, wherein the prompt information is used to prompt end users to complete download of the latest second electronic map data outside the target building.

Optionally, the step of when there is the second electronic map data currently stored in the terminal, and currently stored second electronic map data is not the latest second electronic map data, downloading the latest second electronic map data, includes:
acquiring a latest version number of the second electronic map data;
when there is the second electronic map data currently stored in the terminal, reading a version number of the currently stored second electronic map data; and
when the version number is not the latest version number, downloading the second electronic map data of a latest version with the latest version number.

Optionally, the step of downloading latest second electronic map data includes:
sending a download request for the latest second electronic map data to an electronic map server; and
receiving the latest second electronic map data sent by the electronic map server in response to the download request.

Optionally, the step of acquiring a latest version number of the second electronic map data includes:
receiving the latest version number of the second electronic map data sent by the electronic map server.

Optionally, the transition region surrounds the area occupied by the target building.

Optionally, the first navigation mode includes a GPS navigation mode, and the second navigation mode includes at least one of a Bluetooth navigation mode, a WIFI navigation mode and an ultra-wideband navigation mode.

In a second aspect, the present disclosure further provides a method for processing an electronic map, wherein the method is at least used to generate and send the second electronic map data of the method for switching the electronic map as described in the first aspect, the method is applied to an electronic map server, and the method includes:
generating latest second electronic map data according to latest initial map data of the interior of the target building and the transition region outside the target building, wherein the second electronic map data includes vector data and road network data of the interior of the target building and the transition region outside the target building and position data of short-range positioning auxiliary devices; and
when a download request for the latest second electronic map data sent by the terminal is received, sending the latest second electronic map data to the terminal, so that the terminal switches an electronic map by the method for switching the electronic map as described in the first aspect.

Optionally, the step of generating latest second electronic map data according to latest initial map data of the interior of the target building and the transition region outside the target building includes:
performing compression processing on initial position data of the short-range positioning auxiliary devices; and
performing encryption processing on the initial position data of the short-range positioning auxiliary devices after the compression processing, to obtain the position data of the short-range positioning auxiliary devices.

Optionally, the method further includes:
after generating the latest second electronic map data, when an acquisition request for a latest version number of the second electronic map data sent by the terminal is received, sending the latest version number of the second electronic map data to the terminal; or,
after generating the latest second electronic map data, sending the latest version number of the second electronic map data to the terminal.

In a third aspect, the present disclosure further provides a terminal, including a memory and an executable program stored on the memory, when the program is executed, implementing the steps of the method for switching the electronic map as described in the first aspect.

In a fourth aspect, the present disclosure further provides a server, including a memory and an executable program stored on the memory, when the program is executed, implementing the steps of the method for processing the electronic map as described in the second aspect.

In a fifth aspect, the present disclosure further provides a computer-readable storage medium, storing an executable program, when the program is executed, implementing the steps of the method for switching the electronic map as described in the first aspect, or, when the program is executed, implementing the steps of the method for processing the electronic map as described in the second aspect.

The above description is merely a summary of the technical solutions of the present disclosure. In order to more clearly know the elements of the present disclosure to enable the implementation according to the contents of the description, and in order to make the above and other purposes, features and advantages of the present disclosure more apparent and understandable, the particular embodiments of the present disclosure are provided below.

### BRIEF DESCRIPTION OF THE DRAWINGS

In order to more clearly illustrate the technical solutions of the embodiments of the present disclosure or the related art, the figures that are required to describe the embodiments or the related art will be briefly described below. Apparently, the figures that are described below are embodiments of the present disclosure, and a person skilled in the art can obtain other figures according to these figures without paying creative work.

FIG. 1 illustrates a flow chart of the steps of a method for switching an electronic map according to an embodiment of the present disclosure;

FIG. 2 illustrates a top view of a transition region according to an embodiment of the present disclosure:

FIG. 3 illustrates a top view of another transition region according to an embodiment of the present disclosure:

FIG. 4 illustrates a flow chart of the steps of another method for switching an electronic map according to an embodiment of the present disclosure;

FIG. 5 illustrates a schematic diagram of on-site deployment of a short-range positioning auxiliary device according to an embodiment of the present disclosure;

FIG. 6 illustrates a flow chart of the steps of acquiring second electronic map data according to an embodiment of the present disclosure;

FIG. 7 illustrates a schematic diagram of three circles intersecting according to an embodiment of the present disclosure;

FIG. 8 illustrates a schematic diagram of another three circles intersecting according to an embodiment of the present disclosure;

FIG. 9 illustrates a schematic diagram of yet another three circles intersecting according to an embodiment of the present disclosure:

FIG. 10 illustrates a schematic diagram of execution process of a positioning solution according to an embodiment of the present disclosure:

FIG. 11 illustrates a schematic diagram of a process of a vehicle entering a warehouse according to an embodiment of the present disclosure;

FIG. 12 illustrates a flow chart of the steps of a method for processing an electronic map according to an embodiment of the present disclosure; and

FIG. 13 illustrates a schematic diagram of data flow according to an embodiment of the present disclosure.

### DETAILED DESCRIPTION

In order to make the purpose, technical solutions, and advantages of the embodiment of the present disclosure clearer, the technical solutions according to the embodiments of the present disclosure will be clearly and completely described below with reference to the drawings according to the embodiments of the present disclosure. Apparently, the described embodiments are merely certain embodiments of the present disclosure, rather than all of the embodiments. All of the other embodiments that a person skilled in the art obtains on the basis of the embodiments of the present disclosure without paying creative work fall within the protection scope of the present disclosure.

Unless otherwise defined, technical or scientific terms used in the present disclosure shall have the usual meaning understood by persons skilled in the art to which the present disclosure belongs. The terms “first”. “second”, and similar terms used in the present disclosure do not indicate any order, quantity, or importance, but are only used to distinguish different components. Similarly, similar words such as “one”, “a/an”, or “the” do not indicate a quantity limit, but rather indicate the existence of at least one. Words such as “including” or “comprising” refer to the components or objects that appear before the word, including the components or objects listed after the word and their equivalents, without excluding other components or objects. Words such as “connection” or “connected” are not limited to physical or mechanical connections, but can include electrical connections, whether direct or indirect. Positional words such as “up”. “down”, “left”, and “right” are only used to represent relative positional relationships based on the attached drawings. When the absolute position of the described object changes, the relative positional relationship may also change accordingly.

Referring to FIG. 1, which shows the flow chart of the steps of the method for switching the electronic map according to the embodiment of the present disclosure. The method is applied to a terminal, in some embodiments, the terminal may be a car mounted terminal, or a mobile terminal such as a mobile phone or tablet, and the embodiment of the present disclosure does not provide specific limitations on this.

The method includes the following steps:
step 101: under the condition that a first electronic map is displayed according to first electronic map data, when it is detected that the terminal enters a transition region outside a target building, acquiring second electronic map data, wherein the transition region is adjacent to an area occupied by the target building.

It should be noted in advance that in the embodiment of the present disclosure, the target building can be understood as a single building or as a building complex including at least two single buildings (referred to as a park), and the present disclosure is not intended to limit this. Furthermore, for a building complex, the outside of the target building can be understood as the outdoor range of each single building in the building complex, and correspondingly, the interior of the target building can be understood as the indoor range of each single building in the building complex. The outside of the target building may also be understood as the outdoor range outside the building complex, and correspondingly, the interior of the target building can be understood as the range within the building complex, including the space between the single buildings.

In the embodiment of the present disclosure, the first electronic map data include electronic map data outside the target building. For the convenience of expression, the first electronic map data will be referred to as outdoor electronic map data in the following text. Correspondingly, the first electronic map displayed based on the first electronic map data will be referred to as an outdoor electronic map. The second electronic map data include electronic map data of the interior of the target building and electronic map data of the transition region outside the target building. For the convenience of expression, the second electronic map data will be referred to as indoor electronic map data in the following text. Correspondingly, the second electronic map displayed based on the second electronic map data will be referred to as an indoor electronic map. In addition, for the convenience of expression, in the following text, the process of entering the interior from the outside is called warehousing, and the process of entering the outside from the interior is called outbound.

In addition, the first electronic map data may include vector data and road network data outside the target building, and the second electronic map data may include vector data and road network data of the interior of the target building and the transition region and position data of short-range positioning auxiliary devices.

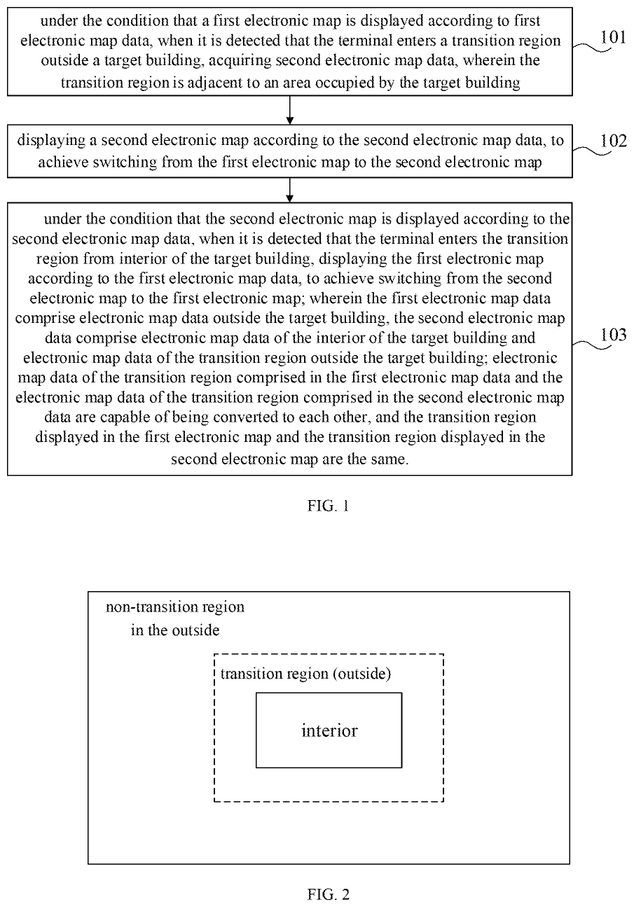

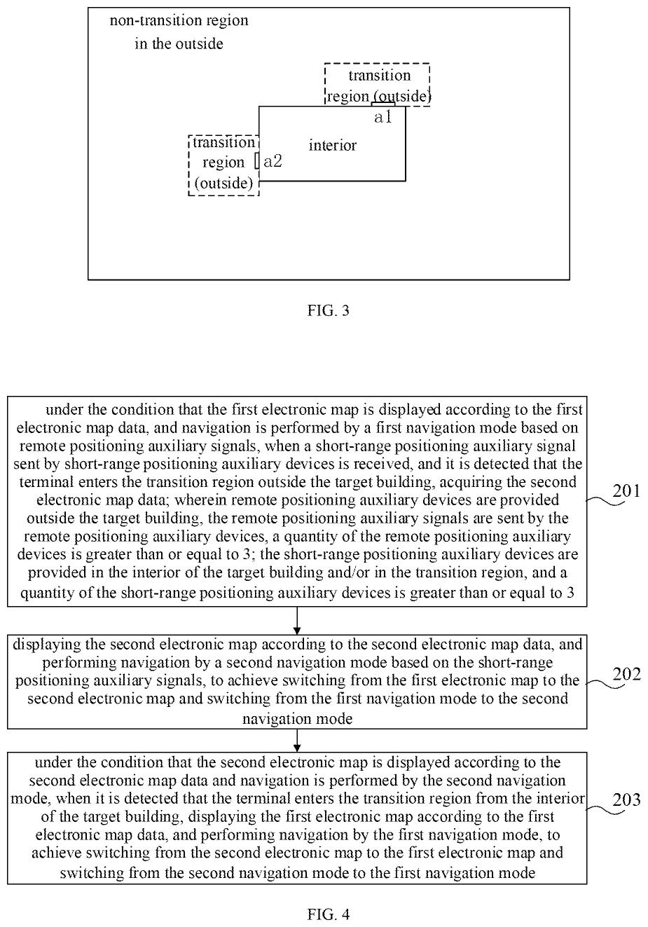

Among them, a transition region may be set in an outdoor area of the target building, and the transition region is adjacent to the area occupied by the target building. In some embodiments, as shown in FIG. 2, the transition region may surround the area occupied by the target building. In other embodiments, there may be some impassable areas at a boundary of the target building, such as greening areas, where the possibility of people or vehicles entering the target building from the impassable area is extremely low. Therefore, as shown in FIG. 3, the transition region may also be set only at the accessible entrance and exit of the target building, such as pedestrian entrance and exit a1 and vehicular entrance and exit a2.

Both the outdoor electronic map data and the indoor electronic map data include the electronic map data of the transition region, and the overlapping area of the indoor electronic map and the outdoor electronic map is the transition region. Setting the transition region can provide buffer time for obtaining the indoor electronic map data and the outdoor electronic map data, thus avoiding situations where a white screen occurs when the required electronic map data is only loaded during switching.

In the embodiment of the present disclosure, when navigating in the outdoor area of the target building, the first electronic map data is used, and the navigation map viewed by the end user is the first electronic map. Under the condition that the terminal displays the first electronic map based on the first electronic map data, that is, under the condition that the terminal navigates in the outdoor area of the target building, and when it is detected that the terminal enters the transition region outside the target building, it is determined that the terminal needs to enter the warehouse, and then the second electronic map data (i.e., the indoor electronic map data) may be obtained, that is, the second electronic map data is loaded.

Step 102: displaying a second electronic map according to the second electronic map data, to achieve switching from the first electronic map to the second electronic map.

After the second electronic map data is loaded completely, the terminal may display the second electronic map according to the second electronic map data, to achieve switching from the first electronic map (that is, the outdoor electronic map) to the second electronic map (that is, the indoor electronic map). Furthermore, the end user may enter the warehouse based on the indoor electronic map.

In the embodiment of the present disclosure, the first electronic map data and the second electronic map data may be constructed based on the same or different coordinate systems, but different coordinate systems can be converted to each other. Therefore, the electronic map data of the transition region included in the first electronic map data and the electronic map data of the transition region included in the second electronic map data can be converted to each other. In specific applications, based on this conversion relationships, the transition region displayed in the first electronic map can be made the same as the transition region displayed in the second electronic map, thus making the end user insensitive to the switching of the electronic maps and achieving seamless switching between the indoor electronic map and the outdoor electronic map, to improve the user experience.

In the embodiment of the present disclosure, when the terminal enters the outdoor transition region from a non-transition region in the outside, the indoor electronic map data can be loaded. After loading is completed, it can be switched to the indoor electronic map data for navigation, and switched to the indoor electronic map and provided to the end user. Because the switching of the indoor electronic map may be completed before entering the interior, rather than loading the indoor electronic map data only when entering the interior, seamless switching between the indoor electronic map and the outdoor electronic map can be achieved when the end users enter the warehouse.

Step 103: under the condition that the second electronic map is displayed according to the second electronic map data, when it is detected that the terminal enters the transition region from interior of the target building, displaying the first electronic map according to the first electronic map data, to achieve switching from the second electronic map to the first electronic map; wherein the first electronic map data include the electronic map data outside the target building, the second electronic map data include the electronic map data of the interior of the target building and the electronic map data of the transition region outside the target building; the electronic map data of the transition region included in the first electronic map data and the electronic map data of the transition region included in the second electronic map data are capable of being converted to each other, and the transition region displayed in the first electronic map and the transition region displayed in the second electronic map are the same.

In the embodiment of the present disclosure, when navigating in the indoor area of the target building, the second electronic map data is used, and the navigation map viewed by the end user is the second electronic map. Under the condition that the terminal displays the second electronic map based on the second electronic map data, that is, when it is detected that the terminal enters the transition region outside the target building from the interior of the target building, it is determined that the terminal needs to exit from the warehouse, and then the second electronic map data is switched to the first electronic map data, and the second electronic map is switched to the first electronic map.

In the embodiment of the present disclosure, when the terminal enters the outdoor transition region from the interior, it can be switched to the outdoor electronic map data for navigation, and switched to the outdoor electronic map and provided to the end user. Because the indoor electronic map data include the electronic map data of the outdoor transition region, when the terminal just enters the outdoor transition region from the interior, the indoor electronic map can still provide navigation services for the transition region, and then it is switched to the outdoor electronic map in the transition region. Therefore, seamless switching between the indoor electronic map and the outdoor electronic map can also be achieved when the end users exit from the warehouse.

In the embodiment of the present disclosure, under the condition that the terminal navigates in the outdoor area of the target building, when it is detected that the terminal enters the transition region outside the target building, it is determined that the terminal needs to enter the interior from the outside, and then the second electronic map data can be obtained, and the second electronic map can be displayed based on the second electronic map data to achieve switching from the outdoor first electronic map to the indoor second electronic map. Under the condition that the terminal navigates in the indoor area of the target building, when it is detected that the terminal enters the transition region outside the target building from the interior, it is determined that the terminal needs to go from the interior to the outside, and then the first electronic map can be displayed based on the first electronic map data to achieve switching from the indoor second electronic map to the outdoor first electronic map. In this way, seamless switching between the indoor electronic map and the outdoor electronic map can be achieved when the end users enter or exit from the interior.

Referring to FIG. 4, which illustrates a flow chart of the steps of another method for switching an electronic map according to an embodiment of the present disclosure. The method is applied to a terminal, and the method includes the following steps:
step 201: under the condition that the first electronic map is displayed according to the first electronic map data, and navigation is performed by a first navigation mode based on remote positioning auxiliary signals, when a short-range positioning auxiliary signal sent by short-range positioning auxiliary devices is received, and it is detected that the terminal enters the transition region outside the target building, acquiring the second electronic map data; wherein remote positioning auxiliary devices are provided outside the target building, the remote positioning auxiliary signals are sent by the remote positioning auxiliary devices, a quantity of the remote positioning auxiliary devices is greater than or equal to 3; the short-range positioning auxiliary devices are provided in the interior of the target building and % or in the transition region, and a quantity of the short-range positioning auxiliary devices is greater than or equal to 3.

Among them, the first navigation mode may include Global Positioning System (GPS) navigation mode. Correspondingly, the remote positioning auxiliary device is a GPS satellite, and the remote positioning auxiliary signal is a GPS signal. In practical applications, outdoor navigation can usually use the GPS navigation mode based on internet electronic maps. In one implementation, it can detect whether the current GPS signal strength meets the predetermined strength. If it is lower than the predetermined strength, it will switch to the indoor electronic map and start indoor positioning navigation. This solution relies on the GPS signal strength, but some scenarios have a significant impact on the GPS signal strength and require adjusting the strength threshold parameters according to different implementation environments, which makes deployment and implementation more cumbersome. For example, for underground buildings such as underground parking lots, and parks with high and dense buildings, the indoor GPS signal strength is usually not high, or even there is no GPS signal. Therefore, the solution of switching between the indoor electronic map and the outdoor electronic map through the GPS signal strength will be greatly affected by the GPS signal strength, which can easily lead to the failure of switching the electronic maps.

Therefore, on the basis of the above embodiments, in addition to the switching between the indoor electronic map data and the outdoor electronic map data, and the switching between the indoor electronic map and the outdoor electronic map, the embodiment can also switch the navigation mode when entering to and exiting from the warehouse, thus adopting a navigation mode based on the remote positioning auxiliary signals suitable for the outside when in the outside, and adopting a navigation mode based on the short-range positioning auxiliary signals suitable for the interior when in the interior.

Specifically, the short-range positioning auxiliary devices can be provided in the interior of the target building and/or in the transition region. Each short-range positioning auxiliary device has a certain signal radiation range. In practical applications, as long as the setting of each short-range positioning auxiliary device ensures that the total signal radiation range covers the interior of the target building and the outdoor transition region.

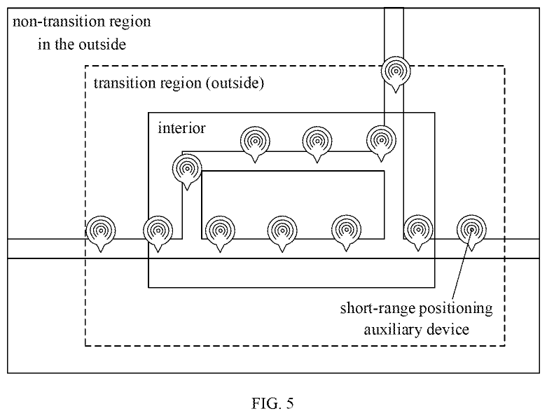

In some embodiments, the short-range positioning auxiliary devices such as indoor Bluetooth beacons can be deployed along the lane and sidewalk of the target building, and the setting distance of the short-range positioning auxiliary devices can be controlled at 6 to 8 meters to ensure uniform distribution. Because the transition region is in the outside, it is switched to the second navigation mode when the second electronic map data is loaded completely. Therefore, it is also necessary to deploy the short-range positioning auxiliary devices such as outdoor Bluetooth beacons in the outside. The deployment area mainly extends to the main road located in the transition region, which is located at the entrance and exit of the target building, as shown in FIG. 5.

Under the condition that the terminal navigates through the first navigation mode in the outdoor area of the target building, the second electronic map data is obtained when the short-range positioning auxiliary signals sent by the short range positioning auxiliary devices are received and it is detected that the terminal enters the transition region outside the target building. That is, when it is necessary to enter the warehouse, detecting whether there is the short-range positioning auxiliary signal such as the Bluetooth signal is more reliable than detecting the GPS signal strength, thus avoiding the impact of on-site environment on the GPS signal strength, and improving the accuracy of determining the switching timing of the electronic maps.

In the embodiment of the present disclosure, by setting the transition region, it is also possible to avoid switching the electronic maps solely based on the presence or absence of the short-range positioning auxiliary signals, thereby avoiding interference from the short-range positioning auxiliary signals. The electronic maps are only switched when there is the short-range positioning auxiliary signal and in the transition region, thus improving the accuracy of determining the switching timing of the electronic maps.

In addition, in some optional embodiments, the step of acquiring the second electronic map data specifically include:
S1: when there is no second electronic map data currently stored in the terminal, downloading latest second electronic map data;
S2: when there is the second electronic map data currently stored in the terminal, and currently stored second electronic map data is not latest second electronic map data, downloading the latest second electronic map data.

Among them, when the terminal detects a short-range positioning auxiliary signal and the current position of the terminal is within the transition region, it starts to download the second electronic map data and caches it offline to the local terminal. If the second electronic map data corresponding to the target building which has already been cached once, it is only necessary to determine whether the second electronic map data is updated during the second and replacement of the target building. If there is an update, it is still necessary to download the latest version again. If there is no update, there is no need to download it again. Directly using locally cached second electronic map data is sufficient.

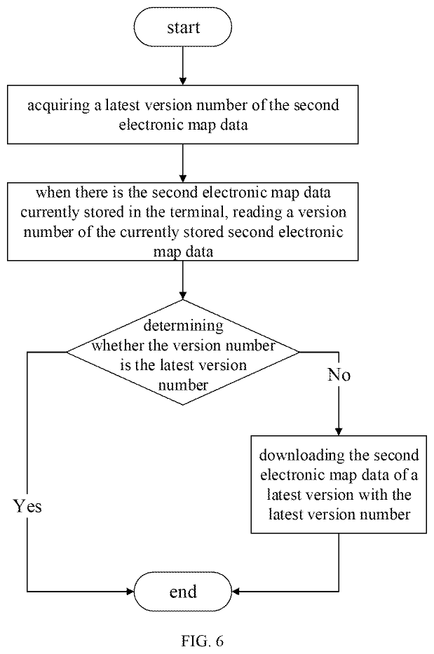

Optionally, referring to FIG. 6, step S2 may specifically include:
S21: acquiring a latest version number of the second electronic map data;
S22: when there is the second electronic map data currently stored in the terminal, reading a version number of the currently stored second electronic map data; and
S23: when the version number is not the latest version number, downloading the second electronic map data of a latest version with the latest version number.

In the embodiment of the present disclosure, different versions of the second electronic map data have different version numbers. The terminal can determine whether the locally stored second electronic map data is the latest second electronic map by comparing whether the version number of the locally stored second electronic map data is consistent with the latest version number provided by the electronic map server. When the two are consistent, it indicates that the locally stored second electronic map data is the latest second electronic map data. When the two are inconsistent, the latest second electronic map data is downloaded. Which can avoid repeated downloads of the second electronic map data and avoid incorrect navigation caused by delayed updates of the second electronic map data.

Optionally, in the step S1 and the step S2, the step of downloading latest second electronic map data may specifically include:
sending a download request for the latest second electronic map data to an electronic map server; and
receiving the latest second electronic map data sent by the electronic map server in response to the download request.

Among them, the latest second electronic map data can be obtained through a request by the electronic map client (hereinafter referred to as the client) and a response from the electronic map server. Among them, an electronic map client is installed on the terminal, the terminal can send the download request of the latest second electronic map data to the electronic map server through the electronic map client. After receiving the download request, the electronic map server can send the latest second electronic map data to the electronic map client. At present, H5 web pages and mini-programs support offline caching, and applications can also support caching to local files on the client.

In practical applications, the frequency of updating the second electronic map data is very low, so the second electronic map data can be provided as a static resource to the electronic map client, thereby fully utilizing the cache of the electronic map client, and reducing the network pressure caused by repeated requests for the second electronic map data. It can also adapt to the scene where the target building has no network.

Optionally, step S21 may specifically include:

receiving the latest version number of the second electronic map data sent by the electronic map server.

In some embodiments, the latest version number of the second electronic map data can also be obtained through a request by the electronic map client and a response from the electronic map server, which means that the terminal can send an acquisition request for the latest version number of the second electronic map data to the electronic map server through the electronic map client. After receiving the acquisition request, the electronic map server may send the latest version number of the second electronic map data to the electronic map client.

In other embodiments, the electronic map server can also proactively send the latest version number of the second electronic map data to each electronic map client after each generation of the latest second electronic map data. The electronic map client can store the latest version number in a designated local storage space, and then directly read the latest version number from the local location when needed.

In addition, in same optional embodiments, in order to ensure the completion of switching the electronic maps before the terminal enters the warehouse, it is necessary to ensure that the second electronic map data is downloaded completely before the terminal enters the warehouse. The method may also include the following steps:
when starting to download the latest second electronic map data, estimating a download duration t1 required for the latest second electronic map data;
according to position information of an entrance of the target building included in the first electronic map data and a movement speed of the terminal entering the transition region, estimating a movement duration t2 of the terminal from entering the transition region to moving to the entrance of the target building; and
when the download duration t1 is greater than the movement duration t2, outputting prompt information, wherein the prompt information is used to prompt end users to complete download of the latest second electronic map data outside the target building.

Among them, when starting to download the latest second electronic map data, the terminal can estimate the download duration t1 based on the data size and current receiving speed of the latest second electronic map data. The terminal can also estimate the movement duration t2 of the terminal in the transition region based on the movement speed when the terminal just enters the transition region and the position information at the entrance of the target building. When the entrance of the target building is not unique, the entrance of the target building which is closest to the terminal can be selected. When the download duration t1 is less than or equal to the movement duration t2, it is expected that the download can be completed before entering the interior of the target building, then the terminal can download the second electronic map data normally. When the download duration t1 is greater than the movement duration t2, it is expected that the download cannot be completed before entering the interior of the target building, then the terminal can output the prompt information through screen display, voice playback, and other methods to prompt the end users to complete the download outside the target building. In practical applications, there are many specific forms of the prompt information, such as voice prompts for the end users to stop and wait for download, display download progress bars, etc. The embodiment of the present disclosure does not specifically limit this.

In some embodiments, due to the uncertainty of factors such as download speed, terminal movement speed, and the movement route of the terminal in the transition region, the terminal can determine the remaining download duration and the movement duration of the terminal moving from the current position to the entrance of the target building in real-time during the movement process within the transition region. Then, whether the download can be completed within the transition region is determined based on these two factors, to enable the end users to enter the interior of the target building as soon as possible after completing the download and the switching of the electronic maps, thereby saving the waiting time for the end users in the transition region.

Step 202: displaying the second electronic map according to the second electronic map data, and performing navigation by a second navigation mode based on the short-range positioning auxiliary signals, to achieve switching from the first electronic map to the second electronic map and switching from the first navigation mode to the second navigation mode.

Optionally, the second navigation mode includes at least one of a Bluetooth navigation mode, a WIFI navigation mode and an ultra-wideband navigation mode.

Optionally, when the second navigation mode is the Bluetooth navigation, the short-range positioning auxiliary device can be a Bluetooth beacon. When the second navigation mode is the WIFI navigation mode, the short-range positioning auxiliary device can be a wireless router. When the second navigation mode is ultra-wideband navigation mode, the short-range positioning auxiliary device can be an ultra wide band (UWB) beacon.

In practical applications, the reception of the short-range positioning auxiliary signals and the navigation based on the short-range positioning auxiliary signals can be achieved based on short-range communication functions of the terminal, that is, the terminal can communicate with the short-range positioning auxiliary devices only when the short-range communication functions of the terminal are in on-state, thus receiving the short-range positioning auxiliary signals. In the embodiment of the present disclosure, the activation of the short-range communication functions of terminal can include the following modes:
Mode 1: the client inquiries the end user if it is possible to activate the short-range communication functions of the terminal when needed. After the end user confirms, the client can activate it, or the end user can manually activate it after asking.
Mode 2: the end users authorize the client in advance to automatically activate the short-range communication functions of the terminal, so that the client can automatically activate it when needed.

In the embodiment of the present disclosure, the client can perform activation inquiry or automatic activation of the short-range communication function of the terminal at times such as detecting that the terminal enters the transition region, detecting that the terminal gradually approaches the target building and not exceeding a preset distance from the target building. It should be noted that in order to ensure normal navigation in the interior of the target building, it is necessary to ensure that the short-range communication functions of the terminal are in on-state at least before entering the target building.

Certainly, in practical applications, if the short-range communication functions are activated before the terminal enters the transition region, the client does not need to perform activation inquiry or automatic activation of the short-range communication function of the terminal in the future.

After the latest second electronic map data is loaded, the terminal can display the second electronic map based on the second electronic map data to switch from the first electronic map (i.e., the outdoor electronic map) to the second electronic map (i.e., the indoor electronic map), and navigate through the second navigation mode based on the short-range positioning auxiliary signals to switch from the outdoor first navigation mode to the indoor second navigation mode. Furthermore, the end users can enter the warehouse based on the indoor electronic map and perform indoor navigation by the second navigation mode.

In some embodiments, the step of performing navigation by a second navigation mode based on the short-range positioning auxiliary signals may specifically include:
S3: during a movement process of the terminal in the interior of the target building or in the transition region, receiving the short-range positioning auxiliary signals sent by the short-range positioning auxiliary devices;
S4: under the condition that the short-range positioning auxiliary signals sent by at least three short-range positioning auxiliary devices are received, according to position data of the at least three short-range positioning auxiliary devices included in the second electronic map data and received signal strength indications when the terminal receives the short-range positioning auxiliary signals, determining a first real-time position of the terminal;
S5: according to road network data of the interior of the target building and the transition region included in the second electronic map data, and a starting position when the terminal enters the transition region and a required end position, determining a first navigation route of the terminal in the interior of the target building and in the transition region; and
S6: performing navigation according to the first real-time position and the first navigation route.

The process implemented in step S4 can be referred to as the positioning solution process, and the process implemented in steps S5-S6 can be referred to as the real-time navigation process.

Among them, the short-range positioning auxiliary devices can continuously send short-range positioning auxiliary signals, i.e., broadcast data packets, to the surrounding area. When the terminal enters the range covered by the short-range positioning auxiliary signals, the short-range positioning auxiliary devices can calculate the received signal strength indication (RSSI) when the terminal receives the short-range positioning auxiliary signal sent by the short-range positioning auxiliary device, and add the received signal strength indication to the current data packet that needs to be broadcasted for broadcasting. Table 1 below provides an example of the content of a broadcast packet.

TABLE 1

| data items | interpretative statements | example values |
|---|---|---|
| name | a name of a short-range positioning | 1837683 |
| | auxiliary device | |
| address | An address of a short-range | 40:06:A0:60:39:CC |
| | positioning auxiliary device | |
| uuid | Unique identification of short-range | fda50693-a4e2-4tb1-afcf-c6eb07647825 |
| | positioning auxiliary devices (such | |
| | as equipment manufacturer) | |
| major | Different setting areas (such as a | 1001 |
| | certain region, a certain floor) | |
| minor | Different device identification | 10001 |
| RSSI | Received signal strength indication | −68 |
| | value | |

It should be noted that the content shown in Table 1 above is only an example of an optional broadcast packet and does not constitute a limitation of the present disclosure.

Because the size of the RSSI value is related to the distance between the terminal and the short-range positioning auxiliary device, the terminal can determine the distance between the terminal and each short-range positioning auxiliary device based on the RSSI values corresponding to at least three short-range positioning auxiliary device. In addition, the real-time position of the terminal can be determined based on the distance between the terminal and each short-range positioning auxiliary device. Specifically, step S4 can include the following steps:
S41: regarding every three of the short-range positioning auxiliary devices of which the short-range positioning auxiliary signals are received as a device group, and grouping the at least three short-range positioning auxiliary devices included in the second electronic map data;
S42: parsing the position data of the at least three short-range positioning auxiliary devices included in the second electronic map data;
S43: determining a distance between the terminal and each of the short-range positioning auxiliary devices according to the received signal strength indications when the terminal receives the short-range positioning auxiliary signals;
S44: for each of the short-range positioning auxiliary devices in each device group, regarding parsed position datum of the short-range positioning auxiliary devices as a center of circle, and regarding a distance between the terminal and each of the short-range positioning auxiliary devices as a radius, to draw a circle; and
S45: for each device group, calculating a signal strength centroid of three circles corresponding to the device group, and averaging the signal strength centroids corresponding to the device groups to obtain the first real-time position of the terminal.

In the above steps, the terminal can first divide every three of all short-range positioning auxiliary devices of which the short-range positioning auxiliary signals are received into a device group, and then read the position data to be parsed of each short-range positioning auxiliary device from the second electronic map data through the unique identifier of each short-range positioning auxiliary device, and then parse the position data to be parsed.

Afterwards, the terminal can determine the distance between the terminal and each short-range positioning auxiliary device based on the received signal strength indications when the terminal receives the short-range positioning auxiliary signals by using the following formula.

d=10\hat{ }{[abs(RSSI)−A]/(10*n)}
where d represents the distance between the terminal and a target short-range positioning auxiliary device, abs represents the absolute value operator, RSSI represents the received signal strength indication (usually being a negative value), A represents the absolute value of the received signal strength indication when the signal transmitter (i.e., the target short-range positioning auxiliary device) and the signal receiver (i.e., the terminal) are separated by 1 meter, and n represents the environmental attenuation factor.

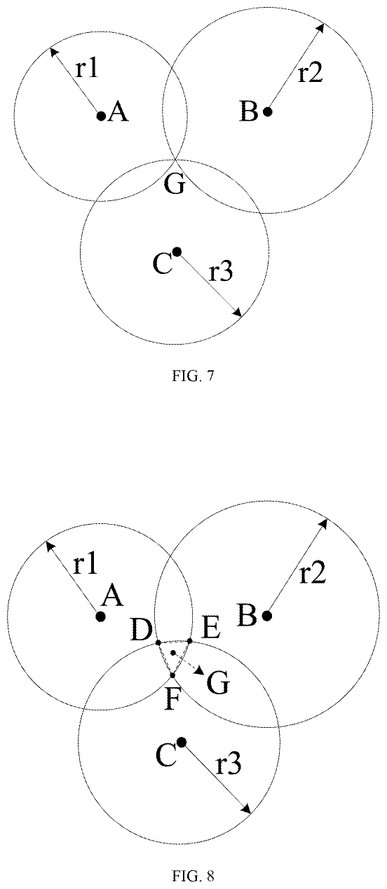

After parsing the position data of each short-range positioning auxiliary device and calculating the distance from the terminal to each short-range positioning auxiliary device, the terminal takes the coordinates of each short-range positioning auxiliary device (A, B, C) in the device group as the center of circle, and takes the parsed distance from the terminal to the short-range positioning auxiliary device (A, B, C) as the radius (r1, r2, r3), to draw three circles, namely (A, r1), (B, r2), and (C, r3). In an ideal state, the coordinates of point G as shown in FIG. 7 at the intersection of three circles are the coordinates of the terminal.

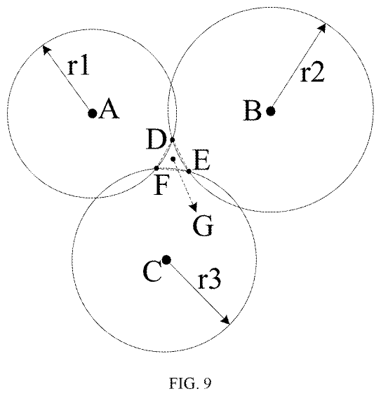

However, in practical applications, there are usually two situations as shown in FIG. 8 and FIG. 9.

The first situation: referring to FIG. 8, the three circles intersect in pairs and there is an intersection of the three circles.

The second situation: referring to FIG. 9, the three circles intersect in pairs, but there is no intersection of the three circles.

For the above two situations, the geometric center G of the triangle DEF can be calculated based on the coordinates of the three closest intersections (D, E, F) of the three circles. The geometric center G is the signal strength centroid corresponding to the device group. Afterwards, the terminal can average the signal strength centroids G corresponding to various device groups. The average calculation can be either a weighted average calculation or a simple average calculation. In specific applications, in order to improve the calculation accuracy of the signal strength centroid, a weighted average calculation can be performed on the signal strength centroid corresponding to each device group based on the principle of larger distance and larger error, so as to obtain the first real-time position of the terminal by calculating.

In practical applications, in order to improve the positioning accuracy of the terminal position, some data required for positioning can be preprocessed. Specifically, when grouping the devices, the condition that the three circles must intersect in pairs can be set, and if the condition is not met, the combination can be excluded. When the RSSI values of the broadcast are received, it is also possible to sort the RSSI values based on their size and remove the limit values at both ends after sorting.

After the terminal calculates and obtains the first real-time position of the terminal in the interior of the target building and in the transition region, the first navigation route of the terminal in the interior of the target building and in the transition region can be planned based on the road network data of the interior of the target building and the transition region included in the second electronic map data, as well as the starting position when the terminal enters the transition region and the required end position.

Optionally, the determination method of the end position can include performing the following steps a1 or step a2 before step S5.
Step a1: acquiring resident positions that are spare and located in the interior of the target building in the second electronic map, and selecting one resident position from the resident positions as the end position; or,
Step a2: acquiring resident positions that are spare and located in the interior of the target building in the second electronic map; when the second electronic map is starting to display, displaying an end position selection interface according to the resident positions that are spare; when a selection operation by an end user for a target resident position in the resident positions that are spare is received in the end position selection interface, determining the target resident position as the end position.

In step a1, the client can first determine which resident positions in the interior of the target building are in an unoccupied idle state, and then the client can select the end position from them by itself. In one implementation, when a resident position is occupied, a user client (clients not specifically specified in the specification are all user clients) facing users can report to a merchant client (such as properties managing the parking lots) facing the target building management merchant, and the user client can obtain the remaining resident positions from the merchant client.

For example, the client can provide a function of automatically finding empty parking spaces, and the spare resident positions are called the empty parking spaces. The client can choose any one from the empty parking spaces or choose one in the order of parking space numbers as the end position, without the need for the end user to choose an empty parking space themselves. In this way, when switching to the indoor electronic maps, the client can navigate to the resident position on its own without the need for the end users to manually determine the end position. For the end users, on the basis of seamless switching between the indoor map and the outdoor map, seamless switching between the indoor navigation and the outdoor navigation is also achieved, so that the end users may directly reach the endpoint.

In step a2, when switching to the indoor electronic map, the client can display the currently unoccupied resident positions to the end user, and then the end user can select a resident position from the interface as the required end position for navigation by clicking or other methods.

For example, the client can display an empty parking space selection interface when starting to display the indoor electronic map. The end user clicks on one of the empty parking spaces, and the client determines the selected empty parking space by clicking as the end position.

In practical applications, the determination of the end position is not limited to the above two methods, but generally includes two ideas: one is to select by the end user himself, and the other is to determine by the client itself. The timing of selecting by the end user himself and determining by the client itself can be different. For example, in some embodiments, the client can provide a terminal pre-selection function, such as an empty parking space pre-selection function, through which the end user can select the end position before going to the target building. In other embodiments, the end position can also be set by the end user after the second electronic map is displayed, that is, when the end user reaches or enters the target building, they select the end position from the second electronic map themselves. For example, in some embodiments, the client can also select the resident position closest to the end user as the end position based on the entry position after the end user enters the target building. The present disclosure is not intended to limit the method and timing of determining the end position.

Furthermore, the terminal can navigate based on the first real-time position in the interior of the target building and in the transition region, as well as the first navigation route determined by the electronic map client.

Optionally, the position data of the at least three short-range positioning auxiliary devices included in the second electronic map data is data obtained after compression processing and encryption processing in sequence, and correspondingly, the step S42 includes:
performing decryption processing on the position data of the at least three short-range positioning auxiliary devices included in the second electronic map data; and
performing decompression processing on the position data of the at least three short-range positioning auxiliary devices after the decryption processing.

Among them, because the second electronic map data will be stored in the terminal for a long time after being downloaded to the terminal, there is a risk of cracking and tampering with the position data of the short-range positioning auxiliary device in the second electronic map data. Therefore, in the embodiment of the present disclosure, the electronic map server can compile the initial position data of the short-range positioning auxiliary device when generating the second electronic map data, that is, the compression processing and the encryption processing are performed in sequence. When the terminal performs positioning solution of the first real-time position, the position data of the short-range positioning auxiliary device that has undergone the compression processing and the encryption processing can be decrypted and decompressed in sequence, thereby achieving the parse of the position data of the short-range positioning auxiliary device and reducing the risk of the position data of the short-range positioning auxiliary device being cracked and tampered during the storage process in the terminal.

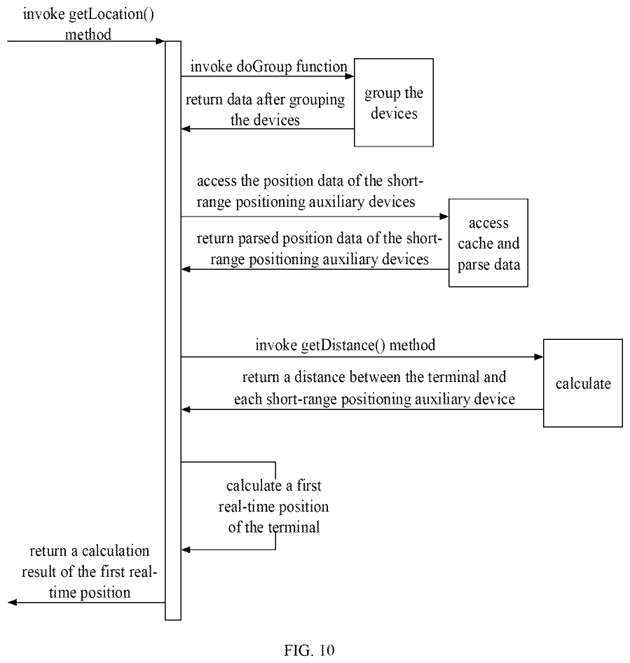

Based on the above content, in practical applications, referring to FIG. 10, an example of an execution process for a positioning solution algorithm can be as follows:
invoking the pre-defined getLocation( ) method in the program, and when the getLocation( ) method runs, first invoking the pre-defined device group grouping function doGroup. The device group grouping function can group the short-range positioning auxiliary devices and return the data after grouping device. Then, access the position data of the short-range positioning auxiliary devices in the terminal cache and parse it to return the parsed data. Next, the pre-defined getDistance( ) method is invoked to calculate the distance from the terminal to each short-range positioning auxiliary device and return the calculated data. The getLocation( ) method can then perform positioning solutions based on the above data to obtain the first real-time position of the terminal.

It should be noted that the names of the methods and functions in the above execution process are only an optional example and do not constitute a restriction for the present disclosure.

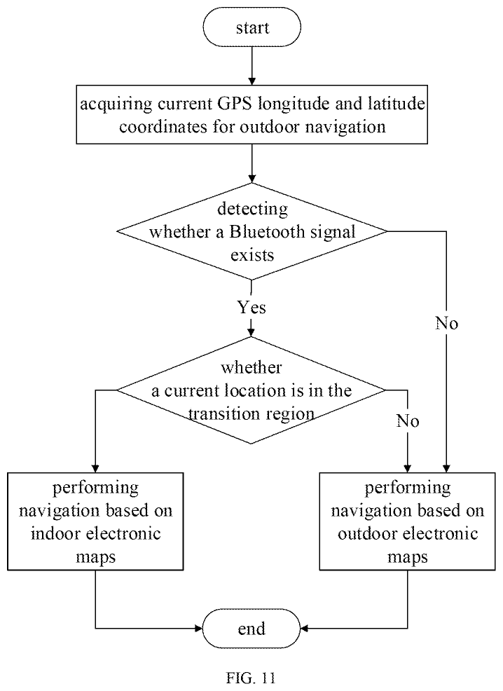

An exemplary warehousing process based on steps 201-202 is provided below, referring to FIG. 11. Taking the navigation of the vehicles into an underground parking lot through an onboard terminal as an example, when the vehicle moves outside the underground parking lot, the onboard terminal can obtain the current GPS longitude and latitude coordinates in real-time, and perform outdoor navigation based on them. During the process, it is detected whether there is a Bluetooth signal. If there is no Bluetooth signal, the vehicle is still navigated based on the outdoor electronic map. If there is a Bluetooth signal, it continues to detect whether the current position of the vehicle is within the transition region. If the current position of the vehicle is not within the transition region, the vehicle is continually navigated based on the outdoor electronic map. If the current position of the vehicle is within the transition region, the indoor electronic map of the underground parking lot is downloaded and cached offline to the local onboard terminal. Then, it is switched to the indoor electronic map to navigate the vehicle, and the vehicle will drive into the underground parking lot based on the navigation.

Step 203: under the condition that the second electronic map is displayed according to the second electronic map data and navigation is performed by the second navigation mode, when it is detected that the terminal enters the transition region from the interior of the target building, displaying the first electronic map according to the first electronic map data, and performing navigation by the first navigation mode, to achieve switching from the second electronic map to the first electronic map and switching from the second navigation mode to the first navigation mode.

When navigating in the interior of the target building, the second electronic map data is used. The navigation map viewed by the end user is the second electronic map, and the navigation mode is the second navigation mode. Under the condition that the terminal displays the second electronic map based on the second electronic map data and navigates through the second navigation mode, when it is detected that the terminal enters the transition region outside the target building from the interior of the target building, it is determined that the terminal needs to exit from the warehouse. Therefore, the second electronic map data can be switched to the first electronic map data, the second electronic map (i.e., the indoor electronic map) can be switched to the first electronic map (i.e., the outdoor electronic map), and the second navigation mode can be switched to the first navigation mode.

In some embodiments, the step of performing navigation by the first navigation mode (based on the remote positioning auxiliary signals) may include:
during a movement process of the terminal outside the target building, receiving the remote positioning auxiliary signals sent by the remote positioning auxiliary devices, wherein the remote positioning auxiliary signals carry sending times of the remote positioning auxiliary signals;
under the condition that the remote positioning auxiliary signals sent by at least three remote positioning auxiliary devices are received, generating initial positioning data according to the sending times and receiving times of the remote positioning auxiliary signals;
sending the initial positioning data to a positioning navigation server, so that the positioning navigation server determines a second real-time position of the terminal according to the initial positioning data and position data of the at least three remote positioning auxiliary devices, determines a second navigation route of the terminal outside the target building according to the second real-time position and road network data outside the target building, generates real-time navigation information according to the second real-time position and the second navigation route, and real-time sends the real-time navigation information to the terminal to navigate the terminal; and
receiving the real-time navigation information.

Among them, during the movement process of the terminal outside the target building, a second electronic map data based on remote positioning auxiliary signals can be used for navigation, such as an internet electronic map based on the GPS signals. Taking the remote positioning auxiliary device as a GPS satellite, and the remote positioning auxiliary signal as a GPS signal as an example, the GPS signal transmitted by the GPS satellite carries a send timestamp of the GPS signal. When the terminal moves outside the target building and receives the GPS signal, it can record the receiving time of the GPS signal and parse the receiving time of the GPS signal. Based on the time difference between the receiving time and the sending time, as well as the signal transmission speed, the distance between the terminal and the GPS satellite that transmits the GPS signal can be calculated. In an optional implementation, the distance between the terminal and the GPS satellite can be calculated by the positioning and navigation server, and accordingly, the initial positioning data maybe the time difference between the receiving time and the sending time. In another alternative implementation, the distance between the terminal and the GPS satellite can also be calculated by the terminal, and accordingly, the initial positioning data may be the distance between the terminal and the GPS satellite which is calculated based on the time difference.

In practical applications, the position data of the remote positioning auxiliary devices is usually managed by the positioning and navigation server, and the client cannot obtain it at will. Therefore, the terminal can send the initial positioning data to the positioning and navigation server. Optionally, when the electronic map server and the positioning and navigation server are the same server, the terminal can directly send the initial positioning data to the positioning and navigation server. When the electronic map server and the positioning and navigation server are not the same server, the terminal can forward the initial positioning data to the positioning and navigation server through the electronic map server. The embodiment of the present disclosure does not specifically limit this.

Furthermore, the positioning and navigation server can determine the second real-time position of the terminal when moving outside the target building based on the initial positioning data and the position data of the at least three remote positioning auxiliary devices. Then, the positioning and navigation server can plan the second navigation route of the terminal outside the target building based on the second real-time position of the terminal and the road network data outside the target building. Based on the second real-time position and the second navigation route, the real-time navigation information can be generated and sent to the terminal in real time for navigation. Among them, the real-time navigation information can include the second real-time position and the second navigation route of the terminal, and other data required for navigation. After receiving the real-time navigation information, the terminal can display the second real-time position of the terminal and the planned second navigation route in real-time on the first electronic map, to make it convenient for the end users to view.

In the embodiment of the present disclosure, under the condition that the terminal navigates in the outdoor area of the target building, when it is detected that the terminal enters the transition region outside the target building, it is determined that the terminal needs to enter the interior from the outside, and then the second electronic map data can be obtained, and the second electronic map can be displayed based on the second electronic map data to achieve switching from the outdoor first electronic map to the indoor second electronic map. Under the condition that the terminal navigates in the indoor area of the target building, when it is detected that the terminal enters the transition region outside the target building from the interior, it is determined that the terminal needs to go from the interior to the outside, and then the first electronic map can be displayed based on the first electronic map data to achieve switching from the indoor second electronic map to the outdoor first electronic map. In this way, seamless switching between the indoor electronic map and the outdoor electronic map can be achieved when the end users enter or exit from the interior.

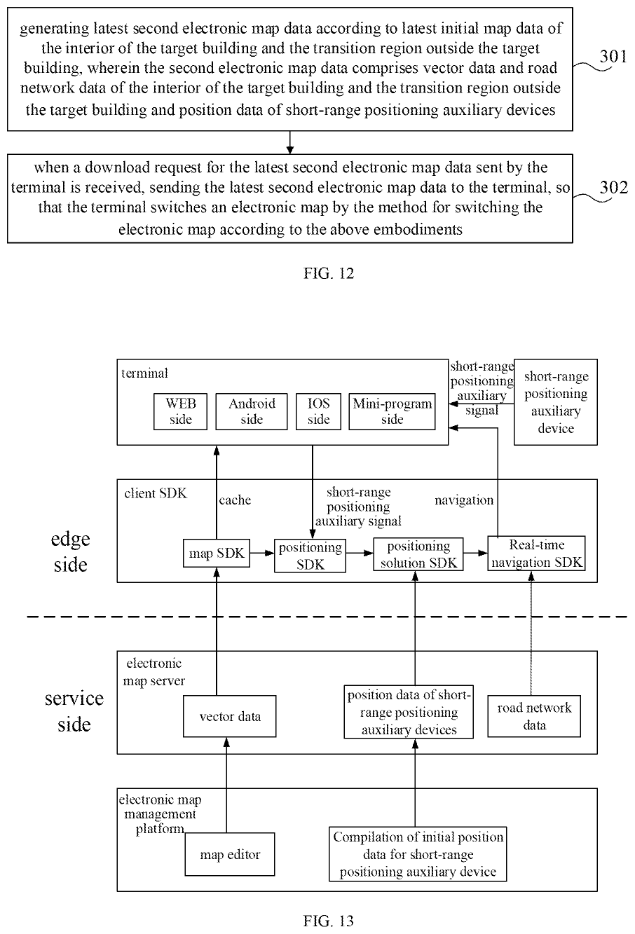

Referring to FIG. 12, which illustrates a flow chart of the steps of a method for processing an electronic map according to an embodiment of the present disclosure. The method is at least used to generate and send the second electronic map data of the method for switching the electronic map as described in the above embodiments, the method is applied to an electronic map server, and the method includes the following steps:
step 301: generating latest second electronic map data according to latest initial map data of the interior of the target building and the transition region outside the target building, wherein the second electronic map data includes vector data and road network data of the interior of the target building and the transition region outside the target building and position data of short-range positioning auxiliary devices.

In the development of the electronic maps on the electronic map server side, it is possible to use the internet vector maps as a base map, on which to draw an electronic map of the interior of the target building. Specifically, based on the construction drawings of the interior of the target building, an electronic map of the interior of the target building can be drawn on the base map using a map editor, and the registration of the transition region can be carried out. This registration may include the calibration of the center point of the target building and the world geographical position of the entrance and exit, which enables the fusion of boundaries between the indoor electronic map and the outdoor electronic map. After drawing and fusion, the electronic map data of the interior of the target building and the transition region outside the target building may be used as the second electronic map data.

When there is a change in the map data of the interior of the target building and the transition region outside the target building, modifications can be made on the basis of the originally generated second electronic map data to update the second electronic map data.

Among them, after deploying the short-range positioning auxiliary devices on the outdoor site of the target building, the short-range positioning auxiliary devices can be marked on the drawn electronic map, and then the position coordinates of the short-range positioning auxiliary devices in the second electronic map can be obtained, which is the initial position data of the short-range positioning auxiliary device.

Optionally, the step of generating latest second electronic map data according to latest initial map data of the interior of the target building and the transition region outside the target building may include:
performing compression processing on initial position data of the short-range positioning auxiliary devices; and
performing encryption processing on the initial position data of the short-range positioning auxiliary devices after the compression processing, to obtain the position data of the short-range positioning auxiliary devices.

Among them, the initial position data of the short-range positioning auxiliary device may be compiled, that is, the compression processing and the encryption processing are performed in sequence. When the terminal performs positioning solution of the first real-time position, the position data of the short-range positioning auxiliary device that has undergone the compression processing and the encryption processing can be decrypted and decompressed in sequence, thereby achieving the parse of the position data of the short-range positioning auxiliary device and reducing the risk of the position data of the short-range positioning auxiliary device being cracked and tampered during the storage process in the terminal.

The generated second electronic map data can support one click publishing to the static resource server managed by the electronic map server. And it supports downloading and offline privatization deployment. In practical applications, the vector data, the road network data, and the position data of the short-range positioning auxiliary device are data files with very low modification frequency, so the second electronic map data can be provided as a static resource to the electronic map client, thereby fully utilizing the cache of the electronic map client, and reducing the network pressure caused by repeated requests for the second electronic map data. It can also adapt to the scene where the target building has no network.

In the embodiment of the present disclosure, the second electronic map data can be updated, and the electronic map server can retain each version of the second electronic map data to ensure that the latest version of the second electronic map data is released without affecting the end users who are currently using it online, and to ensure that the downgraded version can be rolled back in a timely manner when there are problems with the new version.

Step 302: when a download request for the latest second electronic map data sent by the terminal is received, sending the latest second electronic map data to the terminal, so that the terminal switches an electronic map by the method for switching the electronic map as described in the above embodiments.

When the end users need to enter the warehouse, they can send a download request for the latest second electronic map data to the electronic map server through the client. When the electronic map server receives the download request, it can send the currently latest version of the second electronic map data to the client. After receiving it, the client can use the method for switching the electronic map as described in the above embodiments, to switch the first electronic map (i.e., the outdoor electronic map) to the second electronic map (i.e., the indoor electronic map).

Optionally, the method may also include the following steps:
after generating the latest second electronic map data, when an acquisition request for a latest version number of the second electronic map data sent by the terminal is received, sending the latest version number of the second electronic map data to the terminal; or,
after generating the latest second electronic map data, sending the latest version number of the second electronic map data to the terminal.

The electronic map server can label different versions of the second electronic map data with different version numbers. The terminal can obtain the latest version number of the second electronic map data from the electronic map server, and then determine whether the locally stored second electronic map data is the latest second electronic map by comparing whether the version number of the locally stored second electronic map data is consistent with the latest version number provided by the electronic map server. When the two are consistent, it indicates that the locally stored second electronic map data is the latest second electronic map data. When the two are inconsistent, the latest second electronic map data is downloaded. Which can avoid repeated downloads of the second electronic map data and avoid incorrect navigation caused by delayed updates of the second electronic map data.

In some embodiments, the terminal can obtain the latest version number of the second electronic map data through the request by the client and the response from the electronic map server, which means that the terminal can send an acquisition request for the latest version number of the second electronic map data to the electronic map server through the client. After receiving the acquisition request, the electronic map server may send the latest version number of the second electronic map data to the electronic map client.

In other embodiments, the electronic map server can also proactively send the latest version number of the second electronic map data to each electronic map client after each generation of the latest second electronic map data. The electronic map client can store the latest version number in a designated local storage space, and then directly read the latest version number from the local location when needed.

Optionally, in the embodiment of the present disclosure, data such as the movement speed and the movement duration t2 of each terminal in the transition region when entering the warehouse each time can also be collected through the electronic map clients, to form historical movement data. Based on these historical movement data, the electronic map server can adjust the range of the transition region, that is, adjust the distance between the boundary of the transition region and the target building.

Among them, when most of the historical movement data has a high movement speed and a small movement duration, it indicates that most end users need to stop moving or slow down before entering the interior to wait for the second electronic map data download to be completed in the transition region. Therefore, on the electronic map server side, the range of the transition region can be increased. In this way, the second electronic map data can be downloaded completely during the normal movement process of the end user, without the need for the end user to stop outside or slow down to wait for download, thus saving user time and improving the user experience.

When most of the historical moving data has a relatively small movement speed and a relatively long movement duration, it indicates that the second electronic map data can be downloaded completely early before most end users enter the interior. Therefore, on the electronic map server side, the range of the transition region can be reduced, which can reduce the amount of the electronic map data in the transition region, and thus reducing the overall data amount of the second electronic map data, which is conducive to the transmission, storage, and maintenance of the second electronic map data.

In the embodiment of the present disclosure, the electronic map server can generate the latest second electronic map data, under the condition that the terminal navigates in the outdoor area of the target building, when it is detected that the terminal enters the transition region outside the target building, it is determined that the terminal needs to enter the interior from the outside, and then a download request for the latest second electronic map data can be sent to the electronic map server, after receiving the download request, the electronic map server can send the latest second electronic map data to the terminal. The terminal can display the second electronic map based on the second electronic map data acquired from the electronic map server to achieve switching from the outdoor first electronic map to the indoor second electronic map. Under the condition that the terminal navigates in the indoor area of the target building, when it is detected that the terminal enters the transition region outside the target building from the interior, it is determined that the terminal needs to go from the interior to the outside, and then the first electronic map can be displayed based on the first electronic map data to achieve switching from the indoor second electronic map to the outdoor first electronic map. In this way, seamless switching between the indoor electronic map and the outdoor electronic map can be achieved when the end users enter or exit from the interior.

Combining the above content, and referring to FIG. 13, which illustrates a schematic diagram of data flow according to an embodiment of the present disclosure. Among them, at the service side, processes such as editing the second electronic map and compiling the position data of the short-range positioning auxiliary devices can be carried out on the electronic map management platform. Then, through the electronic map server, the second electronic map data including the vector data, the position data of the short-range positioning auxiliary devices, and the road network data can be provided to the edge side.

At the edge side, the client can be a client developed based on the web page (WEB) side, Android side, IOS (Apple operating system) side, or mini-program side, to implement various embodiments of the present disclosure. The Software Development Kit (SDK) in the client can specifically include map SDK, positioning SDK, positioning solution SDK, and real-time navigation SDK. When the end users need to enter the warehouse, the map SDK can download the second electronic map data from the electronic map server and display the second electronic map. The positioning SDK can receive broadcast data from the short-range positioning auxiliary devices and transmit it to the positioning solution SDK. The positioning solution SDK can calculate the real-time position (i.e., the first real-time position) of the terminal in the interior based on the broadcast data and the position data of the short-range positioning auxiliary devices. The real-time navigation SDK can determine the end position in the interior and plan the optimal path between the starting point of entering the transition region and the end position in the interior based on the road network data. Among them, the coordinate system used by the real-time navigation SDK for navigation is the indoor electronic map coordinate system.

Due to the small data amount of the second electronic map, and based on the gradually improved performances of the terminal devices, both the positioning solution process and the real-time navigation processes can be carried out in the terminal. In the embodiment of the present disclosure, the positioning solution service and the real-time navigation service during the indoor navigation process are moved from the service side to the edge side, thus reducing the pressure on the server, improving the real-time positioning, and also adapting to scenarios where the Internet cannot be connected to the interior of the target building.

The embodiment of the present disclosure also discloses a terminal, including a memory and an executable program stored on the memory, and when the program is executed, implementing the steps of the method for switching the electronic map as described in the above embodiments.

The embodiment of the present disclosure also discloses a server, including a memory and an executable program stored on the memory and when the program is executed, implementing the steps of the method for processing the electronic map as described in the above embodiments.

The embodiment of the present disclosure discloses a computer-readable storage medium, which stores an executable program, when the program is executed, implementing the steps of the method for switching the electronic map as described in the above embodiments, or, when the program is executed, implementing the steps of the method for processing the electronic map as described in the above embodiments.

The term “one embodiment”, “embodiment”, or “one or more embodiments” referred to in the specification means that the specific features, structures, or characteristics described in conjunction with the embodiments are included in at least one embodiment of the present disclosure. Furthermore, please note that the example of the term “in one embodiment” may not necessarily refer to the same embodiment.

The manual provided here provides a large number of specific details. However, it can be understood that the embodiments of the present disclosure can be practiced without these specific details. In some examples, well-known methods, structures, and techniques are not shown in detail to avoid blurring the understanding of the specification.

In the claims, any reference symbol between parentheses should not be constructed as a restriction on the claims. The word “comprising” does not exclude the presence of components or steps not listed in the claims. The words “a/an” or “one” before a component do not exclude the existence of multiple such components. The present disclosure can be achieved through hardware comprising several different components and through appropriately programmed computers. Among the unit claims that list several devices, several of these devices can be specifically embodied through the same hardware item. The use of words first, second, and third does not indicate any order. These words can be interpreted as names.

Finally, it should be noted that the above embodiments are only used to illustrate the technical solution of the present disclosure, not to limit it. Although the present disclosure has been described in detail with reference to the aforementioned embodiments, persons skilled in the art should understand that they can still modify the technical solutions recorded in the aforementioned embodiments or equivalently replace some of the technical features. And these modifications or replacements do not separate the essence of the corresponding technical solutions from the spirit and scope of the embodiments of the present disclosure.

1. A method for switching an electronic map, applied to a terminal, wherein the method comprises:
under the condition that a first electronic map is displayed according to first electronic map data, when it is detected that the terminal enters a transition region outside a target building, acquiring second electronic map data, wherein the transition region is adjacent to an area occupied by the target building;
displaying a second electronic map according to the second electronic map data, to achieve switching from the first electronic map to the second electronic map;
under the condition that the second electronic map is displayed according to the second electronic map data, when it is detected that the terminal enters the transition region from interior of the target building, displaying the first electronic map according to the first electronic map data, to achieve switching from the second electronic map to the first electronic map;
wherein the first electronic map data comprise electronic map data outside the target building, the second electronic map data comprise electronic map data of the interior of the target building and electronic map data of the transition region outside the target building; electronic map data of the transition region comprised in the first electronic map data and the electronic map data of the transition region comprised in the second electronic map data are capable of being converted to each other, and the transition region displayed in the first electronic map and the transition region displayed in the second electronic map are the same.

2. The method according to claim 1, wherein the step of under the condition that a first electronic map is displayed according to first electronic map data, when it is detected that the terminal enters a transition region outside a target building, acquiring second electronic map data, comprises:
under the condition that the first electronic map is displayed according to the first electronic map data, and navigation is performed by a first navigation mode based on remote positioning auxiliary signals, when a short-range positioning auxiliary signal sent by short-range positioning auxiliary devices is received, and it is detected that the terminal enters the transition region outside the target building, acquiring the second electronic map data;
wherein remote positioning auxiliary devices are provided outside the target building, the remote positioning auxiliary signals are sent by the remote positioning auxiliary devices, a quantity of the remote positioning auxiliary devices is greater than or equal to 3; the short-range positioning auxiliary devices are provided in the interior of the target building and/or in the transition region, and a quantity of the short-range positioning auxiliary devices is greater than or equal to 3;
the step of displaying a second electronic map according to the second electronic map data, to achieve switching from the first electronic map to the second electronic map, comprises:
displaying the second electronic map according to the second electronic map data, and performing navigation by a second navigation mode based on the short-range positioning auxiliary signals, to achieve switching from the first electronic map to the second electronic map and switching from the first navigation mode to the second navigation mode.

3. The method according to claim 2, wherein the step of under the condition that the second electronic map is displayed according to the second electronic map data, when it is detected that the terminal enters the transition region from interior of the target building, displaying the first electronic map according to the first electronic map data, to achieve switching from the second electronic map to the first electronic map, comprises:
under the condition that the second electronic map is displayed according to the second electronic map data and navigation is performed by the second navigation mode, when it is detected that the terminal enters the transition region from the interior of the target building, displaying the first electronic map according to the first electronic map data, and performing navigation by the first navigation mode, to achieve switching from the second electronic map to the first electronic map and switching from the second navigation mode to the first navigation mode.

4. The method according to claim 2, wherein the step of performing navigation by a second navigation mode based on the short-range positioning auxiliary signals comprises:
during a movement process of the terminal in the interior of the target building or in the transition region, receiving the short-range positioning auxiliary signals sent by the short-range positioning auxiliary devices;
under the condition that the short-range positioning auxiliary signals sent by at least three short-range positioning auxiliary devices are received, according to position data of the at least three short-range positioning auxiliary devices comprised in the second electronic map data and received signal strength indications when the terminal receives the short-range positioning auxiliary signals, determining a first real-time position of the terminal;
according to road network data of the interior of the target building and the transition region comprised in the second electronic map data, and a starting position when the terminal enters the transition region and a required end position, determining a first navigation route of the terminal in the interior of the target building and in the transition region; and
performing navigation according to the first real-time position and the first navigation route.

5. The method according to claim 4, wherein before the step of according to road network data of the interior of the target building and the transition region comprised in the second electronic map data, and a starting position when the terminal enters the transition region and a required end position, determining a first navigation route of the terminal in the interior of the target building and in the transition region, the method further comprises:
acquiring resident positions that are spare and located in the interior of the target building in the second electronic map, and selecting one resident position from the resident positions as the end position;
or,
acquiring resident positions that are spare and located in the interior of the target building in the second electronic map; when the second electronic map is starting to display, displaying an end position selection interface according to the resident positions that are spare; when a selection operation by an end user for a target resident position in the resident positions that are spare is received in the end position selection interface, determining the target resident position as the end position.

6. The method according to claim 3, wherein the step of performing navigation by the first navigation mode comprises:
during a movement process of the terminal outside the target building, receiving the remote positioning auxiliary signals sent by the remote positioning auxiliary devices, wherein the remote positioning auxiliary signals carry sending times of the remote positioning auxiliary signals;
under the condition that the remote positioning auxiliary signals sent by at least three remote positioning auxiliary devices are received, generating initial positioning data according to the sending times and receiving times of the remote positioning auxiliary signals;
sending the initial positioning data to a positioning navigation server, so that the positioning navigation server determines a second real-time position of the terminal according to the initial positioning data and position data of the at least three remote positioning auxiliary devices, determines a second navigation route of the terminal outside the target building according to the second real-time position and road network data outside the target building, generates real-time navigation information according to the second real-time position and the second navigation route, and real-time sends the real-time navigation information to the terminal to navigate the terminal; and
receiving the real-time navigation information.

7. The method according to claim 4, wherein according to position data of the at least three short-range positioning auxiliary devices comprised in the second electronic map data and received signal strength indications when the terminal receives the short-range positioning auxiliary signals, determining a first real-time position of the terminal comprises:
regarding every three of the short-range positioning auxiliary devices of which the short-range positioning auxiliary signals are received as a device group, and grouping the at least three short-range positioning auxiliary devices comprised in the second electronic map data;
parsing the position data of the at least three short-range positioning auxiliary devices comprised in the second electronic map data;
determining a distance between the terminal and each of the short-range positioning auxiliary devices according to the received signal strength indications when the terminal receives the short-range positioning auxiliary signals;
for each of the short-range positioning auxiliary devices in each device group, regarding parsed position datum of the short-range positioning auxiliary devices as a center of circle, and regarding a distance between the terminal and each of the short-range positioning auxiliary devices as a radius, to draw a circle; and
for each device group, calculating a signal strength centroid of three circles corresponding to the device group, and averaging the signal strength centroids corresponding to the device groups to obtain the first real-time position of the terminal.

8. The method according to claim 7, wherein the position data of the at least three short-range positioning auxiliary devices comprised in the second electronic map data is data obtained after compression processing and encryption processing in sequence, and the step of parsing the position data of the at least three short-range positioning auxiliary devices comprised in the second electronic map data comprises:
performing decryption processing on the position data of the at least three short-range positioning auxiliary devices comprised in the second electronic map data; and
performing decompression processing on the position data of the at least three short-range positioning auxiliary devices after the decryption processing.

9. The method according to claim 1, wherein the step of acquiring the second electronic map data comprises:
when there is no second electronic map data currently stored in the terminal, downloading latest second electronic map data; and
when there is the second electronic map data currently stored in the terminal, and currently stored second electronic map data is not latest second electronic map data, downloading the latest second electronic map data.

10. The method according to claim 9, wherein the method further comprises:
when starting to download the latest second electronic map data, estimating a download duration required for the latest second electronic map data;
according to position information of an entrance of the target building comprised in the first electronic map data and a movement speed of the terminal entering the transition region, estimating a movement duration of the terminal from entering the transition region to moving to the entrance of the target building; and
when the download duration is greater than the movement duration, outputting prompt information, wherein the prompt information is used to prompt end users to complete download of the latest second electronic map data outside the target building.

11. The method according to claim 9, wherein the step of when there is the second electronic map data currently stored in the terminal, and currently stored second electronic map data is not the latest second electronic map data, downloading the latest second electronic map data, comprises:
acquiring a latest version number of the second electronic map data;
when there is the second electronic map data currently stored in the terminal, reading a version number of the currently stored second electronic map data; and
when the version number is not the latest version number, downloading the second electronic map data of a latest version with the latest version number.

12. The method according to claim 9, wherein the step of downloading latest second electronic map data comprises:
sending a download request for the latest second electronic map data to an electronic map server; and
receiving the latest second electronic map data sent by the electronic map server in response to the download request.

13. The method according to claim 11, wherein the step of acquiring a latest version number of the second electronic map data comprises:
receiving the latest version number of the second electronic map data sent by the electronic map server.

14. The method according to claim 1, wherein the transition region surrounds the area occupied by the target building.

15. The method according to claim 1, wherein the first navigation mode comprises a GPS navigation mode, and the second navigation mode comprises at least one of a Bluetooth navigation mode, a WIFI navigation mode and an ultra-wideband navigation mode.

16. A method for processing an electronic map, wherein the method is at least used to generate and send the second electronic map data of the method for switching the electronic map according to claim 1, the method is applied to an electronic map server, and the method comprises:
generating latest second electronic map data according to latest initial map data of the interior of the target building and the transition region outside the target building, wherein the second electronic map data comprises vector data and road network data of the interior of the target building and the transition region outside the target building and position data of short-range positioning auxiliary devices; and
when a download request for the latest second electronic map data sent by the terminal is received, sending the latest second electronic map data to the terminal, so that the terminal switches an electronic map by the method for switching the electronic map according to claim 1.

17. The method according to claim 16, wherein the step of generating latest second electronic map data according to latest initial map data of the interior of the target building and the transition region outside the target building comprises:
performing compression processing on initial position data of the short-range positioning auxiliary devices; and
performing encryption processing on the initial position data of the short-range positioning auxiliary devices after the compression processing, to obtain the position data of the short-range positioning auxiliary devices.

18. The method according to claim 16, wherein the method further comprises:
after generating the latest second electronic map data, when an acquisition request for a latest version number of the second electronic map data sent by the terminal is received, sending the latest version number of the second electronic map data to the terminal; or,
after generating the latest second electronic map data, sending the latest version number of the second electronic map data to the terminal.

19. A terminal, wherein the terminal comprises a memory and an executable program stored on the memory, when the program is executed, implementing the steps of the method for switching the electronic map according to claim 1.

20. A server, wherein the server comprises a memory and an executable program stored on the memory, when the program is executed, implementing the steps of the method for processing the electronic map according to claim 16.

21. (canceled)
